(19) United States
(12) Patent Application Publication
(10) Pub. No.: US 2004/0132924 A1
(43) Pub. Date: Jul. 8, 2004

(54) Polyester powder coating materials for coatings with a matt appearance

(75) Inventors: Joern Volker Weiss, Haltern am See (DE); Werner Grenda, Herne (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 10/721,499

(22) Filed: Nov. 26, 2003

(30) Foreign Application Priority Data
Nov. 26, 2002 (DE) 102 55 250.9

(51) Int. Cl. C08L 77/00

(52) U.S. Cl. 525/419; 525/459

(57) ABSTRACT

Powder coating materials based on acidic polyesters, polyureas, crosslinkers, and other customary additives for coatings having a matt appearance.

### BACKGROUND OF THE INVENTION

1. Field of the Invention

The invention describes powder coating materials based on acidic polyesters, polyureas, crosslinkers, and other customary additives for coatings having a matt appearance.

2. Description of the Related Art

Coating systems and processes which give a substrate a uniformly even and matt surface are of considerable interest. The reasons for this are predominantly practical in nature. Glossy surfaces require a far higher degree of cleaning than matt surfaces. Furthermore, it may be desirable on safety grounds to avoid strongly reflecting surfaces.

The simplest method of obtaining a matt surface is to admix smaller or larger amounts of fillers, such as chalk, finely divided silica or barium sulfate, for example, to the powder coating material in accordance with the extent of the desired matt effect. Such additions, however, result in a deterioration in the film properties of the coating, such as adhesion, flexibility, impact strength, and chemical resistance.

The addition of substances incompatible with the coating material, such as waxes or cellulose derivatives, for example, clearly gives rise, to matting, but slight changes in the course of extrusion lead to fluctuations in the surface gloss. The reproducibility of the matt effect obtained from such coating materials is therefore not ensured.

Polyester powder coating materials are materials comprising acidic polyester binders and crosslinkers containing reactive glycidyl and/or hydroxyalkylamide groups. Common commercial crosslinkers, employed worldwide, include triglycidyl isocyanurate (TGIC) and β-hydroxyalkylamide and their derivatives. Powder coating materials based on hydroxyl-containing polyesters are not covered by the general term polyester powder coating materials. Since they are crosslinked exclusively with polyisocyanates, they constitute the group of the polyurethane powder coating materials.

Both polyester and polyurethane powder coating materials result in weathering-stable coating systems, i.e., they can be used for outdoor applications and consequently are of great industrial and economic importance. The possibilities for the matting of both systems have formed the subject of numerous publications and patents, e.g., DE-A 196 30 844, DE-A 196 37 375, DE-A 196 37 377, DE-A 198 16 547, EP 0 698 645, and R. Franiau, Advances in R-hydroxy-alkylamide crosslinking chemistry, ECJ (2002) 10, p. 409.

In DE-A 100 42 318 matt polyurethane powder coating materials are described which are composed of defined hydroxyl-containing polyesters, customary commercial polyisocyanate crosslinkers, and special, separately prepared polyurea matting agents. The matting of the system is achieved through the use of defined hydroxyl-containing polyesters in combination with polyureas.

DE 102 33 103 describes matt polyurethane powder coating materials comprising defined combinations of amorphous and/or (semi)crystalline polyesters, polyureas, crosslinkers, and customary auxiliaries and additives.

Surprisingly, it has now been found that these matting strategies can also be applied to polyester powder coating materials if instead of the combination of amorphous polyesters with crystalline hydroxyl-functionalized polyesters, the corresponding carboxyl-containing polyesters are used in combination with polyureas and, where appropriate, other fillers.

### SUMMARY OF THE INVENTION

Accordingly, an object of the present invention is to provide polyester powder coating materials for coatings having a matt appearance, containing at least

A) 0.5-25% by weight of polyurea,

B) 45-85% by weight of COOH-containing polyester synthesized from polyols and polycarboxylic acids and/or their esters and/or anhydrides, having a COOH number of 15 to 150 mg KOH/g, and containing

B1) 40-80% by weight of at least one amorphous polyester and

B2) 20-60% by weight of at least one (semi)crystalline polyester,

C) 1-20% by weight of at least one crosslinker based on a polyepoxy or polyhydroxyalkylamide compound having a functionality of at least 2, there being from 0.6 to 1.2 reactive crosslinker groups available per COOH group of the polyester.

The polyester powder coating materials may further contain D1) 1-50% by weight of auxiliaries and additives.

### DESCRIPTION OF THE PREFERRED EMBODIMENTS

The polyureas A) of the polyester powder coating materials are described in more detail below. They are known in principle from EP 1 184 399 (those portions of EP 1 184 399 relevant to polyureas is incorporated herein by reference).

To prepare the polyureas it is possible to use any known aliphatic, cycloaliphatic, araliphatic, and/or aromatic isocyanates having at least two NCO groups and their isocyanurates, where available, singly or as any desired mixtures with one another. Examples that may be listed include the following: cyclohexane diisocyanates, methylcyclohexane diisocyanates, ethylcyclohexane diisocyanates, propylcyclohexane diisocyanates, methyldiethylcyclohexane diisocyanates, phenylene diisocyanates, tolylene diisocyanates, bis(isocyanatophenyl)methane, propane diisocyanates, butane diisocyanates, pentane diisocyanates, hexane diisocyanates (e.g., hexamethylene diisocyanate (HDI) or 1,5-diisocyanato-2-methylpentane (MPDI)), heptane diisocyanates, octane diisocyanates, nonane diisocyanates (e.g., 1,6-diisocyanato-2,4,4-trimethylhexane and 1,6-diisocyanato-2,2,4-trimethylhexane (TMDI)), nonane triisocyanates (e.g., 4-isocyanatomethyl-1,8-octane diisocyanate (TIN)), decane di- and -triisocyanates, undecane di- and -triisocyanates, dodecane di- and -triisocyanates, isophorone diisocyanate (IPDI), bis(isocyanatomethylcyclohexyl)methane (H₁₂MDI), isocyanatomethyl-methylcyclohexyl isocyanates, 2,5(2,6)-bis(isocyanatomethyl)bicyclo[2.2.1]heptane (NBDI), 1,3-bis(isocyanatomethyl)cyclohexane (1,3-H₆-XDI), and 1,4-bis(isocyanatomethyl)cyclo-hexane (1,4-H₆-XDI). All regioisomers and stereoisomers of the above-mentioned isocyanates are included. Preference is given to using HDI, IPDI, MPDI, TMDI, 1,3- and 1,4-H₆—XDI, NBDI, and mixtures of HDI and IPDI. Preferred polyureas are those containing IPDI, IPDI isocyanurate, HDI or HDI isocyanurate, and any desired mixtures thereof.

In the context of the invention it is possible to use any aliphatic, (cyclo)aliphatic, cycloaliphatic, and aromatic diamines and/or polyamines (C₅-C₁₈).

Suitable diamines include in principle 1,2-ethylenediamine, 1,2-propylenediamine, 1,3-propylenediamine, 1,2-butylenediamine, 1,3-butylenediamine, 1,4-butylenediamine, 2-(ethylamino)ethylamine, 3-(methylamino)propylamine, 3-(cyclohexylamino)propylamine, 4,4′-diaminodicyclohexylmethane, isophoronediamine (IPD), 4,7-dioxadecane-1,10-diamine, N-(2-aminoethyl)-1,2-ethanediamine, N-(3-aminopropyl)-1,3-propanediamine, N,N″-1,2-ethanediylbis(1,3-propanediamine), and hexamethylenediamines, which may also contain one or more C₁-C₄ alkyl radicals. Mixtures of said amines can also be used. Preference is given to employing isophoronediamine.

It is likewise possible to employ polyamines, such as 4-aminomethyl-1,8-octanediamine, diethylenetriamine, dipropylenetriamine, triethylenetetramine and tetraethylenepentamine. Generally speaking, polyureas with an NCO/NH₂ ratio of from 0.8 to 1.2:1 are prepared. Using equimolar amounts with an NCO/NH₂ ratio of 1:1 produces infinitely crosslinked, solid, and brittle polymers which melt only above 240° C. with decomposition and are insoluble in solvents.

Preferred polyureas in the context of the invention are those containing IPD and IPDI, and/or IPDI isocyanurate, and/or HDI and/or HDI isocyanurate. They have molar masses of more than 4,000 and contain at least 8% by weight, preferably 20% by weight, more preferably from 40 to 100% by weight, of isocyanurates and/or amines having a functionality >2, preferably isocyanurates, more preferably IPDI isocyanurate and/or HDI isocyanurate. Polyureas formed from single isocyanurates and IPD are also preferred. The polyureas are present in the powder coating materials in amounts of from 0.5 to 25% by weight, preferably 3 to 15% by weight, more preferably 5 to 10% by weight.

With regard to the COOH-containing polyester B) it is essential to the invention that it comprises mixtures of 40-80% by weight, preferably 60-70% by weight, of at least one amorphous polyester B1) and 20-60% by weight, preferably 30-40% by weight, of at least one (semi)crystalline polyester B2).

The amorphous polyesters B1) possess a functionality of from 2.0 to 5.0, an acid number of 15-150 mg KOH/g, a glass transition temperature (T_{g}) of from 35 to 85° C., and a weight average molecular weight of from 2,000 to 7,000; the melting range lies between 60 and 110° C. The amorphous polyesters are based on linear or branched polycarboxylic acids and/or derivatives thereof, such as anhydrides and esters, and on aliphatic or cycloaliphatic, linear or branched polyols. The dicarboxylic acid used is isophthalic acid, phthalic acid, adipic acid, azelaic acid, sebacic acid, dodecanedioic acid, trimellitic acid, hexahydroterephthalic acid, hexahydrophthalic acid, succinic acid and/or 1,4-cyclohexanedicarboxylic acid. The polyol component used for the amorphous polyesters comprises linear, aliphatic or cycloaliphatic diols in amounts of at least 80 mol %, based on the total amount of all polyols used. Examples of such diols are monoethylene glycol, diethylene glycol, neopentylglycol hydroxypivalate, neopentylglycol, cyclohexanedimethanol, butane-1,4-diol, pentane-1,5-diol, pentane-1,2-diol, hexane-1,6-diol, and nonane-1,9-diol. In amounts of at most 20 mol % it is possible to use branched, aliphatic or cycloaliphatic polyols as well. Examples of such polyols are trimethylolpropane, glycerol, and pentaerythritol.

The (semi)crystalline polyesters B2) generally have a functionality of from 2.0 to 4.0 and an acid number of 15-150 mg KOH/g. The melting points lie between 60 and 130° C. and the glass transition temperature is <−10° C.; the weight average molecular weight lies between 1,800 and 6,500. The polyesters are based on linear dicarboxylic acids and/or their derivatives, such as anhydrides and esters, and on aliphatic or cycloaliphatic, linear or branched polyols. As dicarboxylic acids use is made of succinic acid, which is preferred, and/or adipic acid and/or sebacic acid and/or dodecanedioic acid in amounts of at least 85 mol %, based on the total amount of all carboxylic acids. In this invention the expression “dicarboxylic acid” always includes the esters, anhydrides or acid chlorides thereof, since they of course can likewise be used. In much lower fractions of up to 15 mol % at most it is also possible if desired to use other aliphatic, cycloaliphatic or aromatic dicarboxylic acids. Examples of such dicarboxylic acids are glutaric acid, azelaic acid, 1,4-, 1,3- or 1,2-cyclohexanedicarboxylic acid, terephthalic acid, and isophthalic acid. As polyol component for the (semi)crystalline polyesters use is made of monoethylene glycol and/or butane-1,4-diol, which is preferred, and/or hexane-1,6-diol in amounts of at least 80 mol %, based on the total amount of all polyols. In amounts of not more than 20 mol % it is also possible to use other aliphatic or cycloaliphatic, linear or branched polyols. Examples of such polyols are diethylene glycol, neopentylglycol hydroxypivalate, neopentylglycol, cyclohexanedimethanol, pentane-1,5-diol, pentane-1,2-diol, nonane-1,9-diol, trimethylolpropane, glycerol, and pentaerythritol.

The (semi)crystalline and amorphous polyesters can be obtained in a conventional manner by condensing polyols and polycarboxylic acids or their esters, anhydrides or acid chlorides in an inert gas atmosphere at temperatures from 100 to 260° C., preferably from 130 to 220° C., in the melt or in an azeotropic regime, as described, for example, in Methoden der Organischen Chemie (Houben-Weyl), vol. 14/2, 1-5, 21-23, 40-44, Georg Thieme Verlag, Stuttgart, 1963, in C. R. Martens, Alkyd Resins, 51-59, Reinhold Plastics Appl. Series, Reinhold Publishing Comp., New York, 1961, or in DE-A 27 35 497 and 30 04 903 (those portions of each relevant to the (semi)crystalline and/or amorphous polyesters is incorporated herein by reference).

As crosslinkers C), it is possible in principle to use any known crosslinkers based on polyepoxides and/or polyhydroxyalkylamides for the powder coatings sector. Preference is given to commercial products, such as ARALDIT PT 810, PT 910, PT 912 (Vantico), PRIMID 552, QM 1260, SF 4510 (Ems) and VESTAGON HA 320 (Degussa) and also PROSID H, S (SIR).

(β-Hydroxyalkylamides are particularly preferred. They are described for example in EP 0 957 082, EP 0 649 890, EP 0 322 834, EP 0 322 807, EP 0 262 872, and U.S. Pat. No. 4,076,917 (those portions of each of which disclose β-hydroxyalkylamides are incorporated herein by reference). One preferred embodiment of the invention uses the following β-hydroxyalkylamides C):

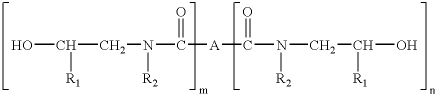

where R₁ is hydrogen, an aromatic radical or a C₁-C₅ alkyl group, R₂ is hydrogen, an aromatic radical, a C₁-C₅ alkyl group or

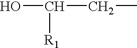

and A is a chemical bond or a monovalent or polyvalent organic group selected from saturated, unsaturated, and aromatic hydrocarbon groups and substituted hydrocarbon groups having 2 to 20 carbon atoms, m is 1 to 2, n is 0 to 2, and m+n is at least 1. With particular preference these compounds have a functionality of four. The β-hydroxyalkylamides are present preferably in amounts of 2-10% by weight, more preferably 3-5% by weight.

The auxiliaries and additives D) optionally present in the polyester powder coating materials of the invention are for example leveling agents, pigments, fillers, and catalysts. They are normally included in amounts of 1-50% by weight but their inclusion is optional. Polyester powder coatings containing only components A), B) and C) may provide cost, processing or performance advantages. Polyester powder coating may further containing the additives or auxiliaries D) in amounts that do not substantially affect the properties of the coating.

To prepare the ready-to-use powder coating materials the COOH-functionalized polyester mixture, crosslinker, polyurea, leveling agent(s), pigments, fillers, and any catalysts are mixed with one another at room temperature and the mixture is subsequently homogenized on an extruder or compounder at temperatures of 100-140° C. The ratio of resin to crosslinker is chosen such that there are from 0.6 to 1.2, preferably 0.8-1.0, reactive crosslinker groups available per COOH group of the resin.

After it has cooled the extrudate is fractionated, ground, and subsequently screened to a particle size <100 μm. The powder produced by this operation is applied to degreased iron panels using an electrostatic powder spraying unit at 60 kV and baked at between 160 to 210° C. in a forced-air drying cabinet.

The formulations contained 30% by weight titanium dioxide (e.g., Kronos 2160 from Kronos), 1% by weight leveling agent (e.g., Resiflow PV 88 from Worlee-Chemie), 0.2-0.5% by weight devolatilizer (e.g., benzoin from Merck-Schuchardt).

### EXAMPLES

1) Polyurea

A 21 three-necked flask equipped with stirrer, dropping funnel, and heating mantle was charged with 70 g of IPD, in dilution in 1,000 ml of toluene. With stirring, the equivalent (NH₂:NCO=1:1) amount of the isocyanurate, diluted with the same amount of toluene, was slowly added dropwise to the initial amine solution charge. When this addition has been made the reaction mixture was heated under reflux for 2 hours more. Subsequently it was cooled to room temperature and the corresponding solid product (polyurea) was isolated by filtration and dried under reduced pressure (at 130 to 170° C. for from 3 to 6 hours).

Polyurea example (amounts in parts by mass)

| | IPD | IPDI traimer¹⁾ |
|---|---|---|
| PH-1 | 70 | 183 |

¹⁾VESTANAT T 1890, Degüssa-Huls AG

The product is a white/colorless, brittle solid which is insoluble in customary solvents and only melts with decomposition at above 240° C.

For use in powder coating materials the product is ground and screened to ≦100 μm.

2) Amorphous polyesters B1)

URALAC P 875, acid number: 35 mg KOH/g, Tg: 56° C. (DSM, Netherlands)

URALAC P 6600, acid number: 33 mg KOH/g, Tg: 57° C. (DSM, Netherlands)

3) Preparation of the (semi crystalline polyester B2)

The (semi)crystalline polyester B2) was prepared by reacting the commercially available crystalline hydroxyl-functionalized polyester Dynacoll 7390 (product of Degussa AG) with succinic anhydride. A 5 liter heatable stirred reactor was charged with 3,500 g of Dynacoll 7390 (OH number 32 mg KOH/g; melting range 105-115° C.), which was melted, and then 210 g of succinic anhydride was added to the melt (about 160° C.) over the course of 10 minutes with stirring. The reaction mixture was subsequently heated at 180-210° C. for 2 hours. Thereafter the acidic polyester was discharged and cooled and the solid product obtained (acid number 34 mg KOH/g; OH number 2 mg KOH/g) was comminuted.

4) Formulations

EXAMPLE 1
Hydroxyalkylamide system
Gloss: 45 scale divisions at 60° [symbol]
Erichsen cupping: 11 mm
Ball impact (direct/reverse): 70/10 in · lb

| Products | % by mass | Ingredients |
|---|---|---|
| Crosslinker | 3.50 | VESTAGON EP-HA 320 |
| Amorphous Polyester | 45.60 | URALAC P 875 |
| Semicrystalline | 19.60 | B2) |
| polyester | | |
| Polyurea | 5.00 | PH1 |
| Pigment TiO₂ | 25.00 | KRONOS 2160 |
| Leveling agent | 1.00 | RESIFLOW PV 88 |
| Devolatilizer | 0.30 | benzoin |

EXAMPLE 2
Hydroxyalkylamide system
Gloss: 30 scale divisions at 60° [symbol]
Erichsen cupping: 11.5 mm
Ball impact (direct/reverse): 110/100 in · lb

| Products | % by mass | Ingredients |
|---|---|---|
| Crosslinker | 3.50 | VESTAGON EP-HA 320 |
| Amorphous polyester | 39.10 | URALAC P 875 |
| Semicrystalline polyester | 26.10 | B2) |
| Polyurea | 5.00 | PH1 |
| Pigment TiO₂ | 25.00 | KRONOS 2160 |
| Leveling agent | 1.00 | RESIFLOW PV 88 |
| Devolatilizer | 0.30 | benzoin |

EXAMPLE 3
TGIC system
Gloss: 37 scale divisions at 60° [symbol]
Erichsen cupping: I 1 mm
Ball impact (direct/reverse): 80/20 in · lb

| Products | % by mass | Ingredients |
|---|---|---|
| Crosslinker | 5.00 | ARALDIT PT 810 |
| Amorphous polyester | 44.45 | URALAC P 6600 |
| Semicrystalline polyester | 19.05 | B2) |
| Polyurea | 5.00 | PH1 |
| Pigment TiO₂ | 25.00 | KRONOS 2160 |
| Leveling agent | 1.00 | RESIFLOW PV 88 |
| Devolatilizer | 0.50 | Benzoin |

EXAMPLE 4
TGIC system
Gloss: 24 scale divisions at 60° [symbol]
Erichsen cupping: 12 mm
Ball impact (direct/reverse): 130/100 in · lb

| Products | % by mass | Ingredients |
|---|---|---|
| Crosslinker | 5.00 | ARALDIT PT 810 |
| Amorphous polyester | 38.10 | URALAC P 6600 |
| Semicrystalline polyester | 25.40 | B2) |
| Polyurea | 5.00 | PH1 |
| Pigment TiO₂ | 25.00 | KRONOS 2160 |
| Leveling agent | 1.00 | RESIFLOW PV 88 |
| Devolatilizer | 0.50 | benzoin |

German application 10255250.9 filed on Nov. 26, 2002 is incorporated herein by reference in its entirety.

Obviously, numerous modifications and variations of the present invention are possible in light of the above teachings. It is therefore to be understood that within the scope of the appended claims, the invention may be practiced otherwise than as specifically described herein.

What is claimed is:

1. A polyester powder coating material comprising
A) 0.5-25% by weight of one or more polyureas,
B) 50-90% by weight of one or more COOH-containing polyesters comprising polymerized units of one or more polyols, and one or more polycarboxylic acids, esters of polycarboxylic acids, or anhydrides of polycarboxylic acids, having a COOH number of 15 to 150 mg KOH/g, and wherein the COOH-containing polyester comprises
B1) 40-80% by weight of at least one amorphous polyester, based on the weight of the COOH-containing polyester and
B2) 20-60% by weight of at least one (semi)crystalline polyester based on the weight of the COOH-containing polyester,
C) 1-25% by weight of at least one of a polyepoxy crosslinker or a polyhydroxyalkylamide crosslinker having a functionality of at least 2,
wherein from 0.6 to 1.2 reactive crosslinker groups are present per COOH group of the polyester, and
wherein % by weight for A), B) and C) is based on the total weight of the coating material.

2. The polyester powder coating material as claimed in claim 1, further comprising 1-50% by weight of one or more auxiliaries or additives.

3. The polyester powder coating material as claimed in claim 1, wherein the polyurea A) comprises polymerized units of at least one difunctional isocyanate and at least one amine having a functionality of at least 2, and has an NCO/NH₂ ratio of from 0.9 to 1.1:1.

4. The polyester powder coating material as claimed in claim 3, wherein the polyurea comprises polymerized units of an isocyanate, an isocyanurate or both an isocyanate and an isocyanurate.

5. The polyester powder coating material as claimed in claim 4, wherein the isocyanate or isocyanurate is selected from the group consisting of IPDI, HDI and HMDI.

6. The polyester powder coating material as claimed in claim 1, wherein the polyurea comprises polymerized units of one or more selected from the group consisting of an aliphatic amine, a (cyclo)aliphatic amine, a cycloaliphatic amine, an aromatic diamine and a polyamine, having 5 to 18 carbon atoms.

7. The polyester powder coating material as claimed in claim 1, comprising IPD.

8. The polyester powder coating material as claimed in claim 1, comprising 3 to 15% by weight of the polyurea.

9. The polyester powder coating material as claimed in claim 1, wherein the COOH-containing polyester comprises
B1) 60-70% by weight of at least one amorphous polyester and
B2) 30-40% by weight of at least one (semi)crystalline polyester.

10. The polyester powder coating material as claimed in claim 1, wherein the amorphous polyester B1) has a functionality of from 2.0 to 5.0, a COOH number of from 5 to 150 mg KOH/g, a melting range of 60 to 110° C. and a glass transition temperature of from 35 to 85° C.

11. The polyester powder coating material as claimed in claim 10, wherein the polyester B1) comprises polymerized units of one or more selected from the group consisting of isophthalic acid, phthalic acid, adipic acid, azelaic acid, sebacic acid, dodecanedioic acid, trimellitic acid, hexahydro-terephthalic acid, hexahydrophthalic acid, succinic acid and 1,4-cyclohexanedicarboxylic acid.

12. The polyester powder coating material as claimed in claim 10, wherein the amorphous polyester comprises polymerized units of at least one of a linear diol, an aliphatic diol or a cycloaliphatic diol, in an amount of at least 80 mol %, based on the total amount of polyols.

13. The polyester powder coating material as claimed in claim 12, comprising polymerized units of at least one of monoethylene glycol, diethylene glycol, neopentylglycol hydroxypivalate, neopentylglycol, cyclohexanedimethanol, butane-1,4-diol, pentane-1,5-diol, pentane-1,2-diol, hexane-1,6-diol, or nonane-1,9-diol.

14. The polyester powder coating material as claimed in claim 12, comprising not more than 20 mol % of branched, aliphatic or cycloaliphatic polyols.

15. The polyester powder coating material as claimed in claim 1, wherein the (semi)crystalline polyester B2) has a functionality of from 2.0 to 4.0, a COOH number of from 5 to 150 mg KOH/g, a melting point of from 60 to 130° C., and a glass transition temperature <−10° C.

16. The polyester powder coating material as claimed in claim 15, wherein the (semi)crystalline polyester B2) comprises polymerized units of one or more selected from the group consisting of succinic acid, adipic acid, sebacic acid, and dodecanedioic acid in an amount of at least 85%, based on the total amount of all carboxylic acids.

17. The polyester powder coating material as claimed in claim 16, comprising not more than 15 mol % of other aliphatic, cycloaliphatic or aromatic dicarboxylic acids.

18. The polyester powder coating material as claimed in claim 17, comprising one or more of glutaric acid; azelaic acid; 1,4-, 1,3- or 1,2-cyclohexanedicarboxylic acid; terephthalic acid; or isophthalic acid.

19. The polyester powder coating material as claimed in claim 15, comprising polymerized units of at least one of monoethylene glycol, butane-1,4-diol or hexane-1,6-diol in an amount of at least 80 mol %, based on the total amount of all polyols.

20. The polyester powder coating material as claimed in claim 19, comprising not more than 20 mol % of any combination of aliphatic, cycloaliphatic, or linear branched polyols.

21. The polyester powder coating material as claimed in claim 20, comprising one or more of diethylene glycol, neopentylglycol hydroxypivalate, neopentylglycol, cyclohexane-dimethanol, pentane-1,5-diol, pentane-1,2-diol, nonane-1,9-diol, trimethylolpropane, glycerol or pentaerythritol.

22. The polyester powder coating material as claimed in claim 1, wherein the crosslinker comprises one or more of TGIC, a compound of TGIC or a β-hydroxyalkylamide.

23. The polyester powder coating material as claimed in claim 22, comprising one or more β-hydroxyalkylamides of the formula 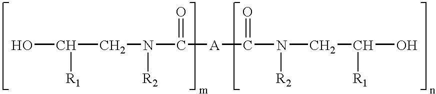
where R₁ is hydrogen, an aromatic radical or a C₁-C₅ alkyl group, R₂ is hydrogen, an aromatic radical, a C₁-C₅ alkyl group or 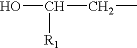
and A is a chemical bond or a monovalent or polyvalent organic group selected from saturated, unsaturated, and aromatic hydrocarbon groups or substituted hydrocarbon groups having from 2 to 20 carbon atoms, m is 1 to 2, n is 0 to 2, and m+n is at least 1.

24. The polyester powder coating material as claimed in claim 23, comprising 2 to 10% by weight of a β-hydroxyalkylamide.

25. A coating comprising the polyester powder coating material of claim 1 and one or more pigments or fillers.

26. A coating obtained by applying the polyester powder coating material of claim 1 onto a substrate.
